(19) United States
(12) Patent Application Publication
(10) Pub. No.: US 2013/0030084 A1
(43) Pub. Date: Jan. 31, 2013

(54) RESIN COMPOSITION AND RESIN-MOLDED PRODUCT

(71) Applicants: Manabu KAWASHIMA, Kanagawa (JP); Masayuki OKOSHI, Kanagawa (JP); Kenji YAO, Kanagawa (JP)

(72) Inventors: Manabu KAWASHIMA, Kanagawa (JP); Masayuki OKOSHI, Kanagawa (JP); Kenji YAO, Kanagawa (JP)

(73) Assignee: FUJI XEROX CO., LTD., Tokyo (JP)

(21) Appl. No.: 13/348,013

(22) Filed: Jan. 11, 2012

(30) Foreign Application Priority Data
Jul. 29, 2011 (JP) 2011-167556

(51) Int. Cl. C08L 63/00; C08L 1/14

(52) U.S. Cl. 523/448; 106/170.18

(57) ABSTRACT

Provided is a resin composition including cellulose acetate propionate; from about phr to about 30 phr of at least one of plasticizer selected from an adipate-based plasticizer and a polyester-based plasticizer; and from about 5 phr to about 50 phr of a condensed phosphoric acid ester compound.

### CROSS-REFERENCE TO RELATED APPLICATIONS

This application is based on and claims priority under 35 USC 119 from Japanese Patent Application No. 2011-167556 filed Jul. 29, 2011.

### BACKGROUND

1. Technical Field

The present invention relates to a resin composition and a resin-molded product.

2. Related Art

Hitherto, various resin compositions have been provided, and these compositions are used for various purposes. Particularly, the resin compositions are used for various parts, chassis, and the like of electronics and automobiles, and thermoplastic resins are also used for parts such as chassis of office equipment and electronic and electric instruments.

In recent years, in reference to global environmental problems, the use of resins derived from plants has aroused high expectations regarding the use of materials that may reduce the amount of greenhouse gas emitted. As one of the resins derived from plants known so far, there is a cellulose derivative. The cellulose derivative has been widely used so far for uses in paints and fibers. However, there have been virtually no examples in which the cellulose derivative is used in resin-molded products.

### SUMMARY

According to an aspect of the invention, there is provided a resin composition including cellulose acetate propionate, from about 5 phr to about 30 phr of at least one of plasticizer selected from an adipate-based plasticizer and a polyester-based plasticizer, and from about 5 phr to about 50 phr of a condensed phosphoric acid ester compound.

### BRIEF DESCRIPTION OF THE DRAWINGS

Exemplary embodiment of the present invention will be described in detail based on the following FIGURE, wherein:

FIG. 1 is a schematic view showing an example of parts of an electronic or electric instrument that include a resin-molded product according to the present exemplary embodiment.

### DETAILED DESCRIPTION

Hereinafter, an exemplary embodiment as an example of the resin composition and the resin-molded product of the exemplary embodiment of the invention will be described.

[Resin Composition]

The resin composition according to the exemplary embodiment of the invention includes cellulose acetate propionate, at least one of plasticizer selected from an adipate-based plasticizer and a polyester-based plasticizer, and a condensed phosphoric acid ester compound.

The content of the cellulose acetate propionate is set to 100 phr, the content of the at least one of plasticizer selected from an adipate-based plasticizer and a polyester-based plasticizer (total content of the two plasticizers when these plasticizers are concurrently used) is set to from 5 phr to 30 phr (or from about 5 phr to about 30 phr), and the content of the condensed phosphoric acid ester compound is set to from 5 phr to 50 phr (or from about 5 phr to about 50 phr).

The “phr” is the abbreviation of “per hundred resin”, and represents “part(s) by mass” based on 100 parts by mass of the total resin component (cellulose propionate in the present exemplary embodiment).

Hitherto, a resin composition composed of a cellulose derivative (cellulose ester) and a plasticizer has been know.

However, it is known that when a plasticizer is mixed with a cellulose derivative (cellulose ester), impact resistance is improved, but the impact resistance deteriorates if a flame retardant is further mixed in. It is considered that this is because the flame retardant is incompatible with the plasticizer.

Therefore, in the resin composition according to the present exemplary embodiment, in addition to selecting cellulose acetate propionate as a cellulose derivative (cellulose ester), a plasticizer is selected from an adipate-based plasticizer and a polyester-based plasticizer, and a composition including 100 phr of cellulose acetate propionate and 5 phr to 30 phr of a plasticizer is mixed with a condensed phosphoric acid ester compound as a flame retardant such that the content of the flame retardant becomes 5 phr to 50 phr.

In the above composition, the impact resistance of a resin-molded product obtained from the resin composition according to the present exemplary embodiment is improved.

Though unclear, the reasons are considered to be as below.

First, it is considered that the cellulose acetate propionate is compatible with the adipate-based plasticizer and the polyester-based plasticizer as plasticizers, and that the addition of a plasticizer decreases intermolecular forces of the cellulose acetate propionate, whereby the impact resistance is improved.

In addition, it is considered that when the condensed phosphoric acid ester compound is mixed as a flame retardant, the condensed phosphoric acid ester compound becomes compatible with the adipate-based plasticizer and polyester-based plasticizer as plasticizers, and that interaction is caused between the phosphoric acid ester of the condensed phosphoric acid ester compound and a carboxyl group of the plasticizer by a hydrogen bond. It is also considered that the structure of the condensed phosphoric acid ester compound serves as a steric barrier, so the intermolecular forces of the cellulose acetate propionate further decrease, and consequently, the impact resistance is further improved compared to a case where only the plasticizer is mixed.

Therefore, it is considered that the impact resistance of a resin-molded product obtained from the resin composition according to the exemplary embodiment is improved by the composition described above, particularly, the impact resistance in a moist heat environment is improved (The moist heat environment refers to an environment in which a temperature is 65° C. and humidity is 85%. The term refers to the same environment in the following description if there is no specific definition.). Consequently, cracking of the obtained resin-molded product, by impact, for example, is suppressed.

It is also considered that by the composition described above, in the resin-molded product obtained from the resin composition according to the exemplary embodiment, glossiness is reduced and mechanical characteristics (particularly, elongation) are improved. By the improvement of the mechanical characteristics (particularly, elongation), for example, stress concentrated by screwing of bosses or the like and self-tapping is easily dispersed, and accordingly, damage to the resin-molded product is easily suppressed.

Herein, it is known that the gloss of the resin-molded product is caused by diffused reflection of different types of respective components on the surface of the product. However, it is considered that the gloss of the obtained resin-molded product is reduced since the respective components are dispersed in the product while being compatible with each other to such a degree that the diffused reflection does not easily occur.

It is also considered that the mechanical characteristics (particularly, elongation) are also improved since the respective components are dispersed while being compatible with each other.

Moreover, it is considered that from the resin composition according to the exemplary embodiment, resin-molded products having impact resistance and a shape retaining property equivalent to those of a resin-molded product including an acrylonitrile-butadiene-styrene resin, a resin-molded product including an acrylonitrile-butadiene-styrene resin and polycarbonate, and the like are obtained due to the above-described characteristics.

The resin composition according to the exemplary embodiment desirably contains an aromatic condensed phosphoric acid ester compound represented by the following Structural Formula (1) as the condensed phosphoric acid ester compound, in addition to the adipate-based plasticizer as a plasticizer.

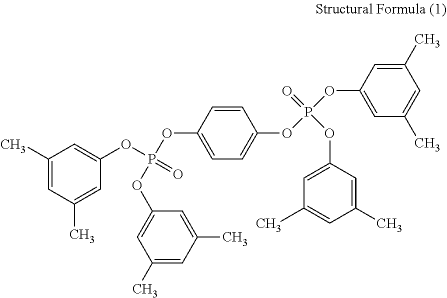

In this manner, the impact resistance of the obtained resin-molded product is easily improved.

The reason is unclear, but it is considered that this is because the plasticizer and the condensed phosphoric acid ester compound are easily compatible with the cellulose acetate propionate.

In this respect, it is considered that the respective components mixed in the resin composition according to the exemplary embodiment desirably have a difference (absolute value) in solubility parameter (SP value) of 8 or less (desirably 5 or less).

If the components having the difference (absolute value) in solubility parameter (SP value) in the above-described range are used, the components become easily compatible with each other, and the impact resistance and other mechanical characteristics are easily improved.

The solubility parameter (SP value) is a value calculated from the following Fedor's equation based on heat of vaporization (Δei) and a molar volume (Δvi) of atoms or an atomic group in a chemical structure.

SP value=(ΣΔei/ΣΔvi)^{1/2}

The resin composition according to the exemplary embodiment desirably further contains from 0.1 phr to 10 phr (or from about 0.1 phr to about 10 phr) of a copolymer of methacrylate and a glycidyl compound.

In this manner, dimensional stability of the obtained resin-molded product is improved.

In the current circumstances in which the use of resins derived from plants is increasingly being demanded due to environmental problems, it is known that the dimensional stability of the obtained resin-molded product becomes insufficient if a composition is used which includes a resin derived from plants, that is, a cellulose derivative (cellulose ester), as abundant as 50 phr or more. It is known that this tendency becomes more marked in a moist heat environment.

On the other hand, when a gel fraction of the resin composition according to the exemplary embodiment in which the copolymer of methacrylate and a glycidyl compound is mixed is measured, the gel fraction is shown to be increased. Accordingly, it is considered that an epoxy group included in the copolymer (glycidyl compound as a polymerization component thereof) of methacrylate and a glycidyl compound and a hydroxyl group included in the cellulose acetate propionate bind to each other, and that a crosslinked structure is formed by the binding.

Therefore, it is considered that the dimensional stability of the obtained resin-molded product is improved if the copolymer of methacrylate and a glycidyl compound is mixed in the resin composition according to the exemplary embodiment. As a result, the obtained resin-molded product is suppressed from contracting in the moist heat environment, and for example, the resin-molded product is suppressed from cracking by stress concentration or the like.

Particularly, it is considered that if the copolymer of methacrylate and a glycidyl compound that is considered to form a crosslinked structure with the cellulose acetate propionate is used, due to the crosslinked structure, the dimensional stability as well as the impact resistance and elastic modulus of the resin-molded product are improved.

It is also considered that if the copolymer of methacrylate and a glycidyl compound that is considered to form a crosslinked structure with the cellulose acetate propionate is used, due to the crosslinked structure, melt viscosity of the resin composition is improved, and moldability is also improved.

Hereinafter, the respective components of the resin composition according to the exemplary embodiment will be described in detail.

(Resin)

—Cellulose Acetate Propionate—

The cellulose acetate propionate is obtained by esterifying cellulose with propionic acid.

The weight average molecular weight of the cellulose acetate propionate is not particularly limited, but is preferably in a range of from 10000 to 100000, and more preferably in a range of from 15000 to 80000.

If the weight average molecular weight is too small, it is difficult to process the composition in some cases due to excessive fluidity, and if the weight average molecular weight is too large, it is difficult to process the composition in some cases due to insufficient fluidity.

The weight average molecular weight is a value measured by using a gel permeation chromatography instrument (manufactured by Shimadzu Corporation, Prominence GPC model) and a measurement column Shim-pack GPC-80M.

The total amount of the cellulose acetate propionate contained in the resin composition is 100 phr.

In this content, the resin composition (the molded product thereof) is certified by “GreenPla” or “BiomassPla” identification system established by Japan BioPlastics Association.

(Plasticizer)

As a plasticizer, at least one kind selected from an adipate-based plasticizer and a polyester-based plasticizer is used. These plasticizers share common characteristics in that they are compatible with cellulose acetate propionate and have a carboxyl group which interacts with a condensed phosphoric acid ester compound as a flame retardant by a hydrogen bond.

Examples of the adipate-based plasticizer include bis(2-ethylhexyl)adipate, diisodecyl adipate, benzyl octyl adipate, and the like.

Examples of the polyester-based plasticizer include poly(1,3-butanediol adipate), polyethylene adipate, polybutylene adipate, polyethylene succinate, polybutylene succinate, and the like.

Among these plasticizers, the adipate-based plasticizer, particularly, bis(2-ethylhexyl)adipate is desirable in view of the improvement of the impact resistance of the obtained resin-molded product. Examples of commercially available products of bis(2-ethylhexyl)adipate include DOP manufactured by DAIHACHI CHEMICAL INDUSTRY CO., LTD.

The weight average molecular weight of the plasticizer is not particularly limited, but is preferably in a range of from 300 to 3000.

If the weight average molecular weight is too small, it is difficult to process the composition in some cases due to excessive fluidity, and a molding defect easily occurs in some cases due to the gasification of the plasticizer in a molding process. If the weight average molecular weight is too large, it is difficult to process the composition in some cases due to insufficient fluidity caused by defective dispersion of the plasticizer.

The content of the plasticizer in the resin composition is from 5 phr to 30 phr, but desirably from 5 phr to 15 phr.

If the content is too small, the impact resistance of the resin-molded product tends not to be easily improved, and if the content is too large, the moldability of the resin composition deteriorates, and the tensile strength of the obtained resin-molded product is reduced in some cases.

(Flame Retardant)

As a flame retardant, a condensed phosphoric acid ester compound is used.

Examples of the condensed phosphoric acid ester compound include an aromatic condensed phosphoric acid ester compound, and specific examples thereof include pentaerythritol diphosphate and phosphoric acid ester compounds represented by the following General Formulae (I) and (II)

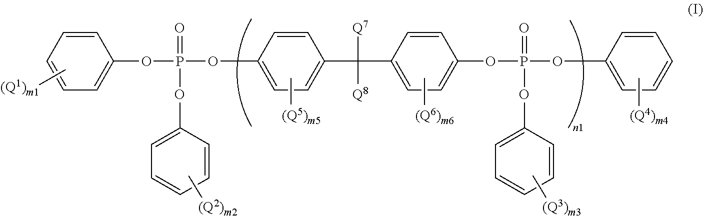

In General Formula (I), each of Q¹, Q², Q³, and Q⁴ independently represents a hydrogen atom or an alkyl group having from 1 to 6 carbon atoms; each of Q⁵, Q⁶, Q⁷, and Q⁸ independently represents a hydrogen atom or a methyl group; each of m1, m2, m3, and m4 independently represents an integer of from 0 to 3; each of m5 and m6 independently represents an integer of from 0 to 2; and n1 represents an integer of from 0 to 10.

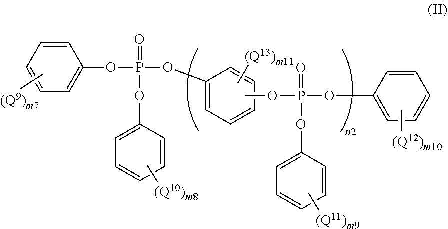

In General Formula (II), each of Q⁹, Q¹⁰, Q¹¹, and Q¹² independently represents a hydrogen atom or an alkyl group having from 1 to 6 carbon atoms; Q¹³ represents a hydrogen atom or a methyl group; each of m7, m8, m9, and m10 independently represents an integer of from 0 to 3; m11 represents an integer of from 0 to 4; and n2 represents an integer of from 0 to 10.

Among the condensed phosphoric acid ester compounds, for example, a bisphenol A type, a biphenylene type, an isophthalic type, and the like of aromatic condensed phosphoric acid esters are desirable in view of the improvement of the impact resistance of the obtained resin-molded product.

Examples of the commercially available products of the aromatic condensed phosphoric acid ester compound include PX-200, PX-201, PX-202, CR-733S, CR-741, CR-747, and the like manufactured by DAIHACHI CHEMICAL INDUSTRY CO., LTD.

Particularly, as the condensed phosphoric acid ester compound, the aromatic condensed phosphoric acid ester compound (commercially available product: PX-200 manufactured by DAIHACHI CHEMICAL INDUSTRY CO., LTD.) represented by the following Structural Formula (1) is desirable in view of the improvement of the impact resistance of the obtained resin-molded product.

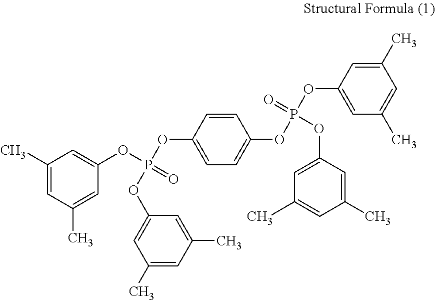

The resin composition contains, for example, from 5 phr to 50 phr of the flame retardant (condensed phosphoric acid ester compound), and desirably contains from 10 phr to 30 phr of the flame retardant.

If this content is too small, the impact resistance of the obtained resin-molded product easily deteriorates, and the flame retardancy of the resin-molded product is not easily exhibited. On the other hand, if the content is too large, the moldability of the resin composition deteriorates, and the exterior of the resin-molded product is impaired in some cases since the flame retardant appears (bleeds) on the surface of the resin-molded product.

(Copolymer of Methacrylate and Glycidyl Compound)

The copolymer of methacrylate and a glycidyl compound is obtained by copolymerizing methacrylate and a glycidyl compound. Structurally, the copolymer may have a ladder structure or a block copolymer structure. In addition, acrylate may be copolymerized in this copolymer instead of methacrylate.

Examples of the glycidyl compound include glycidyl methacrylate, glycidyl acrylate, and the like, and among these, glycidyl methacrylate is desirable.

In the copolymer of methacrylate and a glycidyl compound, a copolymerization ratio between methacrylate and a glycidyl compound is, for example, desirably from 100/100 to 1000/1, more desirably from 100/50 to 1000/2, and even more desirably from 100/50 to 1000/3, in terms of a mass ratio (methacrylate/glycidyl compound).

The weight average molecular weight of the copolymer of methacrylate and a glycidyl compound is, for example, desirably from 500 to 100000, more desirably from 500 to 75000, and even more desirably from 500 to 50000.

The resin composition desirably contains, for example, from 0.1 phr to 10 phr of the copolymer of methacrylate and a glycidyl compound, and more desirably contains from 1 phr to 5 phr of the copolymer.

If this content is too small, the dimensional stability of the obtained resin-molded product is not easily improved. On the other hand, if the content is too large, the moldability of the resin composition deteriorates in some cases.

(Other Components)

The resin composition according to the exemplary embodiment may further contain other components in addition to the respective components described above, within a range that does not impair the effects of the exemplary embodiment.

Examples of other components include a flame retardant aid, a drip preventing agent, a plasticizer, an antioxidant, a mold release agent, a light resistant agent, a weather resistant agent, a colorant, a pigment, a modifier, an antistatic agent, a hydrolysis preventing agent, a filler, a reinforcing agent (such as glass fiber, carbon fiber, talc, clay, mica, glass flakes, milled glass, glass beads, crystalline silica, alumina, silicon nitride, alumina nitride, and boron nitride), and the like.

The resin composition contains other components described above, for example, at from 0 phr to 10 phr, and more desirably at from 0 phr to 5 phr. Herein, “0 phr” refers to an embodiment in which other components are not contained.

(Production Method of Resin Composition)

The resin composition according to the exemplary embodiment is produced by melting and kneading the respective components described above.

As a melting and kneading device, known devices may be used, and examples of the device include a twin screw extruder, a Henschel mixer, a Bunbury mixer, single screw extruder, a multi-screw extruder, a cokneader, and the like.

[Resin-Molded Product]

The resin-molded product according to the exemplary embodiment is configured with the resin composition according to the exemplary embodiment. Specifically, the resin-molded product according to the exemplary embodiment is obtained by molding the resin composition according to the exemplary embodiment.

The resin composition according to the exemplary embodiment is molded by, for example, molding methods such as injection molding, extrusion molding, blow molding, hot-press molding, calendar molding, coating molding, cast molding, dipping molding, vacuum molding, transfer molding, and the like, thereby obtaining resin-molded product according to the exemplary embodiment.

The injection molding may be performed by, for example, commercially available apparatuses such as NEX500, NEX150, and NEX70000 manufactured by Nissei Plastic Industrial Co., Ltd., SE50D manufactured by TOSHIBA MACHINE CO., LTD., and the like. At this time, a cylinder temperature is preferably in a range of from 170° C. to 230° C., and more preferably in a range of from 180° C. to 230° C., in view of suppressing degradation of the resin. In addition, a mold temperature is preferably in a range of from 30° C. to 100° C., and more preferably in a range of from 30° C. to 60° C., in view of productivity.

The resin-molded product according to the exemplary embodiment is suitably used for uses such as electronic and electric instruments, home appliances, containers, interior materials of automobiles, and the like. More specifically, the resin-molded product is used for chassis, various parts, and the like of home appliances and electronic and electric instruments; storage cases of wrapping films, CD-ROMs, DVDs, and the like; containers; food trays; beverage bottles; drug packaging materials; and the like. Among these, the resin-molded product is suitable for parts of electronic and electric instruments.

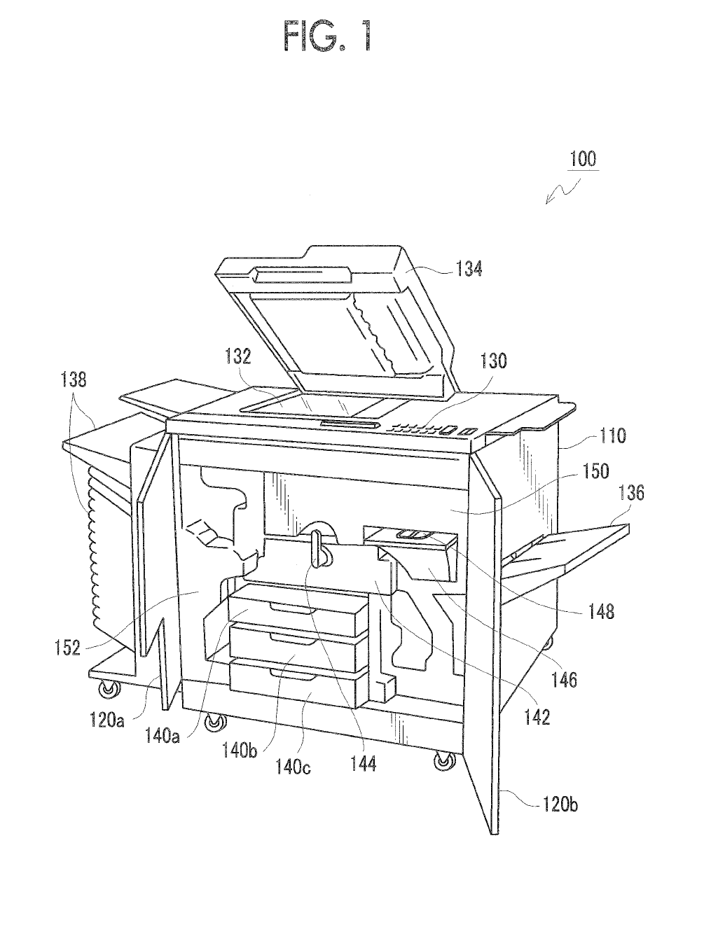

FIG. 1 is a perspective exterior view taken from the front side of an image forming apparatus which is an example of parts of an electronic and electric instrument including the molded product according to the exemplary embodiment.

An image forming apparatus 100 in FIG. 1 includes front covers 120a and 120b on the front surface of main device 110. These front covers 120a and 120b are freely opened and closed such that an operator operates the inside of the apparatus. Therefore, the operator replenishes toners when the toners are used up, replaces process cartridges used up, or removes jammed papers when a paper jam occurs in the apparatus. FIG. 1 shows the apparatus in a state where the front covers 120a and 120b are opened.

The top surface of the main device 110 is provided with an operation panel 130 in which all conditions relating to image formation, such as paper size and number of copies, are input by the operator's operation, and a copy glass 132 on which document to be read is disposed. In addition, the top portion of the main device 110 is provided with an automatic document feeding device 134 that feeds a document onto the copy glass 132. The main device 110 also includes an image reader that obtains image data showing the document image by scanning the document image disposed on the copy glass 132. The image data obtained by the image reader is transmitted to an image forming unit through a control portion. The image reader and the control portion are accommodated inside a chassis 150 that configures a portion of the main device 110. The image forming unit is provided in the chassis 150 as an attachable and detachable process cartridge 142. The process cartridge 142 is detached or attached when an operation lever 144 is turned.

A toner accommodating portion 146 is provided in the chassis 150 of the main device 110, and a toner is replenished from a toner supplying port 148. The toner accommodated in the toner accommodating portion 146 is supplied to a developing device.

The lower portion of the main device 110 is provided with paper storage cassettes 140a, 140b, and 140c. In the main device 110, plural transport rollers configured with a pair of rollers are arranged, whereby a transport path is formed in which paper in the paper storage cassette is transported to the image forming unit in the upper portion. The papers in each paper storage cassette are taken out sheet by sheet by a paper taking-out mechanism disposed near the end of the transport path, and transported to the transport path. In addition, a manual paper feeding portion 136 is provided in the lateral side of the main device 110, so paper is also fed from this portion.

The papers in which an image has been formed by the image forming unit are sequentially transported to a portion between two fixing rolls that are supported by a chassis 152 configuring a portion of the main device 110 and contact to each other, and then discharged outside the main device 110. In the main device 110, plural paper discharge portions 138 are provided in the opposite side of the side where the paper feeding portion 136 is provided, and papers in which images have been formed are discharged to these paper discharge portions.

In the image forming apparatus 100, the resin-molded product according to the exemplary embodiment is used for, for example, the front covers 120a and 120b, the exterior of the process cartridge 142, and the chassis 150 and 152.

### EXAMPLES

Hereinafter, the exemplary embodiment of the invention will be described in detail based on examples, but the exemplary embodiment of the invention is not limited to the examples.

### Examples 1 to 20 and Comparative Examples 1 to 12

The components shown in Tables 1 to 5 are kneaded by a two-axis kneader (manufactured by TOSHIBA MACHINE CO., LTD., TEM58SS) at a cylinder temperature of 210° C., thereby obtaining pellets of resin compositions.

The obtained pellets are subjected to injection molding by using an injection molding machine (manufactured by Nissei Plastic Industrial Co., Ltd., product name “NEX500”), at cylinder temperatures shown in Tables 1 to 5 and at a mold temperature of 50° C., thereby forming an ISO multi-purpose dumbbell test sample (corresponding to ISO527 tensile test and ISO178 bending test, a test portion thickness of 4 mm, a width of 10 mm), and a UL test sample (thickness: 1.6 mm) for a V test in UL-94.

[Evaluation]

(Plant-Derived Content)

The plant-derived content of the resin composition used in each example is calculated by the following equation.

Equation:

plant-derived content=mass of cellulose acetate propionate×(mass of cellulose/mass of cellulose acetate propionate)/total mass

(Gloss)

The obtained ISO multi-purpose dumbbell test sample is visually observed, thereby investigating the existence of gloss.

(Flame Retardancy)

—UL-V Test—

By using the UL test sample for a V test, a UL-V test is conducted using a UL chamber (manufactured by Toyo Seiki Seisaku-sho, Ltd.), based on a method specified by a UL-94HB test. The results are expressed in a descending order as V-0, V-1, V-2, and HB from a high flame retardancy, and when the flame retardancy is poorer than HB, that is, when flame spreads in the test sample, the result is expressed as “failure”.

The pellets that fail to be injection-molded and to be formed into a test sample are not investigated since they are substantially unable to produce products.

(Mechanical Characteristics)

—Tensile Strength and Elongation—

By using the ISO multi-purpose dumbbell test sample, tensile strength and elongation are investigated using an evaluation apparatus (manufactured by Shimadzu Corporation, precision universal testing machine autograph AG-IS 5kN), based on ISO527.

—Impact Resistance—

Notch processing is performed on the ISO multi-purpose dumbbell test sample. By using this sample, Charpy impact strength is measured by a Charpy impact test by using an evaluation apparatus (manufactured by Toyo Seiki Seisaku-sho, Ltd., DG-UB2), based on JIS-K7111 (2006).

—Heat Deflection Temperature (HDT)—

By using the ISO multi-purpose dumbbell test sample, a heat deflection temperature under a load of 1.8 MPa is measured using an HDT measuring apparatus (manufactured by Toyo Seiki Seisaku-sho, Ltd., HDT-3), based on an ISO178 bending test.

(Moist Heat Resistance)

—Impact Resistance after Moist Heat Test—

The ISO multi-purpose dumbbell test sample is subjected to a moist heat test in the following manner, and then the Charpy impact strength is measured in the same manner as described above.

The moist heat test is conducted using a moist heat tester (THN042PA, manufactured by ADVANTEC MFS, INC.), in a condition of 65° C.×85%×400 hours.

—Dimensional Stability—

Before and after the moist heat test is conducted with respect to the ISO multi-purpose dumbbell test sample, the dimensional change (before moist heat test/after moist heat test) of the dumbbell test sample in a TD direction (width direction) is investigated.

—Bleeding—

The ISO multi-purpose dumbbell test sample is visually observed, thereby investigating whether bleeding occurs.

TABLE 1

| | | | Exam- | Exam- | Exam- | Exam- | Exam- | Exam- | Exam- | Exam- |
|---|---|---|---|---|---|---|---|---|---|---|
| | | | ple 1 | ple 2 | ple 3 | ple 4 | ple 5 | ple 6 | ple 7 | ple 8 |
| Composition | Resin | CAP482 | 100 | 100 | 100 | 100 | 100 | 100 | 100 | 100 |
| of resin | | (manufactured by Eastman Chemical | | | | | | | | |
| composition | | Company) | | | | | | | | |
| | Plasticizer | DOP (manufactured by DAIHACHI | 5 | 10 | 30 | 5 | 10 | 30 | 5 | 10 |
| | | CHEMICAL INDUSTRY CO., LTD.) | | | | | | | | |
| | | (bis(2-ethylhexyl) adipate) | | | | | | | | |
| | Crosslinking | MODIPER A4400 (manufactured by NOF | | | | | | | | |
| | agent | CORPORATION) | | | | | | | | |
| | | MODIPER CL430G (manufactured by | | | | | | | | |
| | | NOF CORPORATION) | | | | | | | | |
| | | lotader 8900 (manufactured by ARKEMA) | | | | | | | | |
| | Flame retardant | PX-200 (manufactured by DAIHACHI | 5 | 5 | 5 | 20 | 20 | 20 | 50 | 50 |
| | | CHEMICAL INDUSTRY CO., LTD.) | | | | | | | | |
| | | CR-741 (manufactured by DAIHACHI | | | | | | | | |
| | | CHEMICAL INDUSTRY CO., LTD.) | | | | | | | | |
| | | PX-202 (manufactured by DAIHACHI | | | | | | | | |
| | | CHEMICAL INDUSTRY CO., LTD.) | | | | | | | | |
| | Total amount (phr) | | 110 | 115 | 135 | 125 | 130 | 150 | 155 | 160 |
| Injection temperature (cylinder temperature) | | | 200 | 200 | 200 | 200 | 200 | 200 | 200 | 200 |
| Evaluation | Plant-derived content | | 47 | 45 | 39 | 42 | 40 | 35 | 34 | 33 |
| | Gloss | | present | present | present | present | present | present | present | present |
| | Flame retardancy | | HB | HB | HB | V2 | V2 | V2 | V2 | V2 |
| | Mechanical | Tensile strength (MPa) | 35 | 32 | 30 | 33 | 29 | 27 | 29 | 27 |
| | characteristics | Elongation (%) | 16 | 24 | 30 | 21 | 31 | 34 | 27 | 35 |
| | | Impact resistance (J/cm²) | 14 | 16 | 15 | 18 | 19 | 17 | 16 | 14 |
| | | Heat deflection temperature HDT (° C.) | 70 | 64 | 52 | 50 | 52 | 47 | 47 | 44 |
| | Moist heat | Impact resistance after moist heat test | 16 | 17 | 15 | 19 | 20 | 17 | 16 | 14 |
| | resistance | (J/cm²) | | | | | | | | |
| | | Dimensional stability (%) | 1.3 | 1.2 | 1.1 | 1.2 | 1.2 | 1 | 1.1 | 1 |
| | Exterior | Bleeding (visual observation) | absent | absent | absent | absent | absent | absent | absent | absent |

TABLE 2

| | | | Exam- | Exam- | Exam- | Exam- | Exam- | Exam- | Exam- | Exam- |
|---|---|---|---|---|---|---|---|---|---|---|
| | | | ple 9 | ple 10 | ple 11 | ple 12 | ple 13 | ple 14 | ple 15 | ple 16 |
| Composition of | Resin | CAP482 | 100 | 100 | 100 | 100 | 100 | 100 | 100 | 100 |
| resin | | (manufactured by Eastman Chemical | | | | | | | | |
| composition | | Company) | | | | | | | | |
| | Plasticizer | DOP (manufactured by DAIHACHI | 30 | 15 | 20 | 10 | 10 | 10 | 10 | 10 |
| | | CHEMICAL INDUSTRY CO., LTD.) | | | | | | | | |
| | | (bis(2-ethylhexyl) adipate) | | | | | | | | |
| | Crosslinking | MODIPER A4400 (manufactured by | | | | | | 0.1 | 5 | 10 |
| | agent | NOF CORPORATION) | | | | | | | | |
| | | MODIPER CL430G (manufactured by | | | | | | | | |
| | | NOF CORPORATION) | | | | | | | | |
| | | lotader 8900 (manufactured by | | | | | | | | |
| | | ARKEMA) | | | | | | | | |
| | Flame | PX-200 (manufactured by DAIHACHI | 50 | 20 | 20 | 10 | 30 | 20 | 20 | 20 |
| | retardant | CHEMICAL INDUSTRY CO., LTD.) | | | | | | | | |
| | | CR-741 (manufactured by DAIHACHI | | | | | | | | |
| | | CHEMICAL INDUSTRY CO., LTD.) | | | | | | | | |
| | | PX-202 (manufactured by | | | | | | | | |
| | | DAIHACHI CHEMICAL INDUSTRY | | | | | | | | |
| | | CO., LTD.) | | | | | | | | |
| | Total amount (phr) | | 180 | 135 | 140 | 120 | 140 | 130.1 | 135 | 140 |
| Injection temperature (cylinder temperature) | | | 200 | 200 | 200 | 200 | 200 | 200 | 200 | 200 |
| Evaluation | Plant-derived content | | 29 | 39 | 37 | 43 | 37 | 40 | 39 | 37 |
| | Gloss | | present | present | present | present | present | present | present | present |
| | Flame retardancy | | V2 | V2 | V2 | V2 | V2 | V2 | V2 | V2 |
| | Mechanical | Tensile strength (MPa) | 25 | 29 | 29 | 29 | 29 | 30 | 31 | 33 |
| | characteristics | Elongation (%) | 40 | 31 | 31 | 31 | 31 | 33 | 36 | 38 |
| | | Impact resistance (J/cm²) | 13 | 19 | 18 | 17 | 18 | 19 | 20 | 22 |
| | | Heat deflection temperature HDT (° C.) | 42 | 52 | 50 | 56 | 49 | 52 | 53 | 53 |
| | Moist heat | Impact resistance after moist heat test | 11 | 20 | 19 | 20 | 20 | 20 | 20 | 20 |
| | resistance | (J/cm²) | | | | | | | | |
| | | Dimensional stability (%) | 0.8 | 1.2 | 1.1 | 1.2 | 1 | 0.6 | 0.3 | 0.2 |
| | Exterior | Bleeding (visual observation) | present | absent | absent | absent | absent | absent | absent | absent |

TABLE 3

| | | | Example 17 | Example 18 | Example 19 | Example 20 |
|---|---|---|---|---|---|---|
| Composition | Resin | CAP482 | 100 | 100 | 100 | 100 |
| of resin | | (manufactured by Eastman Chemical | | | | |
| composition | | Company) | | | | |
| | Plasticizer | DOP (manufactured by DAIHACHI | 5 | 5 | 10 | 10 |
| | | CHEMICAL INDUSTRY CO., LTD.) | | | | |
| | | (bis(2-ethylhexyl) adipate) | | | | |
| | Crosslinking agent | MODIPER A4400 (manufactured by NOF | | | | |
| | | CORPORATION) | | | | |
| | | MODIPER CL430G (manufactured by NOF | 5 | | | |
| | | CORPORATION) | | | | |
| | | lotader 8900 (manufactured by ARKEMA) | | 5 | | |
| | Flame retardant | PX-200 (manufactured by DAIHACHI | 20 | 20 | | |
| | | CHEMICAL INDUSTRY CO., LTD.) | | | | |
| | | CR-741 (manufactured by DAIHACHI | | | 20 | |
| | | CHEMICAL INDUSTRY CO., LTD.) | | | | |
| | | PX-202 (manufactured by DAIHACHI | | | | 20 |
| | | CHEMICAL INDUSTRY CO., LTD.) | | | | |
| | Total amount (phr) | | 130 | 130 | 130 | 130 |
| Injection temperature (cylinder temperature) | | | 200 | 200 | 200 | 200 |
| Evaluation | Plant-derived content | | 40 | 40 | 40 | 40 |
| | Gloss | | present | present | present | present |
| | Flame retardancy | | V2 | V2 | V2 | V2 |
| | Mechanical | Tensile strength (MPa) | 33 | 34 | 26 | 27 |
| | characteristics | Elongation (%) | 24 | 26 | 28 | 31 |
| | | Impact resistance (J/cm²) | 17 | 18 | 15 | 17 |
| | | Heat deflection temperature HDT (° C.) | 50 | 51 | 49 | 50 |
| | Moist heat | Impact resistance after moist heat test | 18 | 18 | 16 | 19 |
| | resistance | (J/cm²) | | | | |
| | | Dimensional stability (%) | 0.3 | 0.3 | 1.2 | 1.2 |
| | Exterior | Bleeding (visual observation) | absent | absent | absent | absent |

TABLE 4

| | | | Com- | Com- | Com- | Com- | Com- | Com- | Com- | |
|---|---|---|---|---|---|---|---|---|---|---|
| | | | parative | parative | parative | parative | parative | parative | parative | Com- |
| | | | Exam- | Exam- | Exam- | Exam- | Exam- | Exam- | Exam- | parative |
| | | | ple 1 | ple 2 | ple 3 | ple 4 | ple 5 | ple 6 | ple 7 | Example 8 |
| Composition | Resin | CAP482 | 100 | 100 | 100 | 100 | 100 | 100 | 100 | 100 |
| of resin | | (manufactured by Eastman Chemical | | | | | | | | |
| composition | | Company) | | | | | | | | |
| | Plasticizer | DOP (manufactured by DAIHACHI | | 3 | 3 | 3 | 33 | 33 | 5 | 10 |
| | | CHEMICAL INDUSTRY CO., LTD.) | | | | | | | | |
| | | (bis(2-ethylhexyl) adipate) | | | | | | | | |
| | Crosslinking | MODIPER A4400 (manufactured by | | | | | | | | |
| | agent | NOF CORPORATION) | | | | | | | | |
| | | MODIPER CL430G (manufactured | | | | | | | | |
| | | by NOF CORPORATION) | | | | | | | | |
| | | lotader 8900 (manufactured by | | | | | | | | |
| | | ARKEMA) | | | | | | | | |
| | Flame | PX-200 (manufactured by DAIHACHI | | 5 | 10 | 50 | 5 | 10 | 3 | 3 |
| | retardant | CHEMICAL INDUSTRY CO., LTD.) | | | | | | | | |
| | | CR-741 (manufactured by DAIHACHI | | | | | | | | |
| | | CHEMICAL INDUSTRY CO., LTD.) | | | | | | | | |
| | | PX-202 (manufactured by DAIHACHI | | | | | | | | |
| | | CHEMICAL INDUSTRY CO., LTD.) | | | | | | | | |
| | Total amount (phr) | | 100 | 108 | 113 | 153 | 138 | 143 | 108 | 113 |
| Injection temperature (cylinder temperature) | | | 220 | 200 | 200 | 200 | 200 | 200 | 200 | 200 |
| Evaluation | Plant-derived content | | 52.0 | 48.1 | 46.0 | 34.0 | 37.7 | 36.4 | 48.1 | 46.0 |
| | Gloss | | | present | present | present | present | present | present | present |
| | Flame retardancy | | HB | HB | V2 | V2 | HB | V2 | HB | HB |
| | Mechanical | Tensile strength (MPa) | 52 | 36 | 35 | 27 | 29 | 28 | 36 | 32 |
| | characteristics | Elongation (%) | 12 | 16 | 19 | 30 | 32 | 34 | 16 | 25 |
| | | Impact resistance (J/cm²) | 7 | 7 | 9 | 5 | 12 | 14 | 10 | 12 |
| | | Heat deflection temperature HDT | 102 | 74 | 57 | 47 | 51 | 49 | 70 | 64 |
| | | (° C.) | | | | | | | | |
| | Moist heat | Impact resistance after moist heat | 10 | 9 | 10 | 6 | 15 | 16 | 12 | 16 |
| | resistance | test (J/cm²) | | | | | | | | |
| | | Dimensional stability (%) | 1.4 | 1.3 | 1.2 | 1.1 | 1.1 | 1 | 1.3 | 1.2 |
| | Exterior | Bleeding (visual observation) | absent | absent | absent | absent | absent | absent | absent | absent |

TABLE 5

| | | | | Comparative | Comparative | Comparative |
|---|---|---|---|---|---|---|
| | | | Comparative | Example | Example | Example |
| | | | Example 9 | 10 | 11 | 12 |
| Composition of resin | Resin | CAP482 | 100 | 100 | 100 | 100 |
| composition | | (manufactured by Eastman Chemical Company) | | | | |
| | Plasticizer | DOP (manufactured by DAIHACHI CHEMICAL | 30 | 5 | 10 | 30 |
| | | INDUSTRY CO., LTD.) | | | | |
| | | (bis(2-ethylhexyl) adipate) | | | | |
| | Crosslinking | MODIPER A4400 (manufactured by NOF | | | | |
| | agent | CORPORATION) | | | | |
| | | MODIPER CL430G (manufactured by NOF | | | | |
| | | CORPORATION) | | | | |
| | | lotader 8900 (manufactured by ARKEMA) | | | | |
| | Flame retardant | PX-200 (manufactured by DAIHACHI | 3 | 53 | 53 | 53 |
| | | CHEMICAL INDUSTRY CO., LTD.) | | | | |
| | | CR-741 (manufactured by DAIHACHI | | | | |
| | | CHEMICAL INDUSTRY CO., LTD.) | | | | |
| | | PX-202 (manufactured by DAIHACHI | | | | |
| | | CHEMICAL INDUSTRY CO., LTD.) | | | | |
| | Total amount (phr) | | 133 | 158 | 163 | 183 |
| Injection temperature (cylinder temperature) | | | 200 | 200 | 200 | 200 |
| Evaluation | Plant-derived content | | 39.1 | 32.9 | 31.9 | 28.4 |
| | Gloss | | present | present | present | present |
| | Flame retardancy | | HB | V2 | V2 | V2 |
| | Mechanical | Tensile strength (MPa) | 31 | 29 | 28 | 25 |
| | characteristics | Elongation (%) | 30 | 30 | 35 | 42 |
| | | Impact resistance (J/cm²) | 11 | 7 | 10 | 8 |
| | | Heat deflection temperature HDT (° C.) | 52 | 46 | 43 | 40 |
| | Moist heat | Impact resistance after moist heat test (J/cm²) | 13 | 10 | 14 | 11 |
| | resistance | Dimensional stability (%) | 1.1 | 1.1 | 1 | 0.8 |
| | Exterior | Bleeding (visual observation) | absent | absent | present | present |

From the above results, it is understood that the impact resistance has been improved in the present examples compared to comparative examples. Specifically, from Example 1 and Comparative Examples 2 and 7, Example 3 and Comparative Examples 5 and 9, Example 7 and Comparative Examples 4 and 10, and Example 9 and Comparative Example 12, it is understood that the impact resistance has been improved more in the respective examples, than in the respective comparative examples.

In addition, it is understood that the impact resistance has been improved more in Example 5 that contains an aromatic condensed phosphoric acid ester compound represented by Structural Formula (1) as a condensed phosphoric acid ester compound, than in Examples 19 and 20 that do not contain the aromatic condensed phosphoric acid ester compound represented by Structural Formula (1).

Moreover, it is understood that the dimensional stability has been improved more in Examples 14 to 18 that use a specific amount of a copolymer of methacrylate and a glycidyl compound, than in Example 5.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition comprising:
cellulose acetate propionate;
from about 5 phr to about 30 phr of at least one of plasticizer selected from an adipate-based plasticizer and a polyester-based plasticizer; and
from about 5 phr to about 50 phr of a condensed phosphoric acid ester compound.

2. The resin composition according to claim 1,
wherein a difference (absolute value) in solubility parameter (SP value), which is calculated from the following Fedor's equation based on heat of vaporization (Δei) and a molar volume (Δvi) of atoms or anatomic group in a chemical structure, between the plasticizer and the condensed phosphoric acid ester compound is 8 or less:
SP value=(ΣΔei/ΣΔvi)^{1/2}

3. The resin composition according to claim 1,
wherein the adipate-based plasticizer is one selected from bis(2-ethylhexyl)adipate, diisodecyl adipate, and benzyl octyl adipate.

4. The resin composition according to claim 1,
wherein the polyester-based plasticizer is one selected from poly(1,3-butanediol adipate), polyethylene adipate, polybutylene adipate, polyethylene succinate, and polybutylene succinate.

5. The resin composition according to claim 1,
wherein the condensed phosphoric acid ester compound is an aromatic condensed phosphoric acid ester compound.

6. The resin composition according to claim 1,
wherein the condensed phosphoric acid ester compound is a phosphoric acid ester compound represented by the following General Formula (I) or (II): 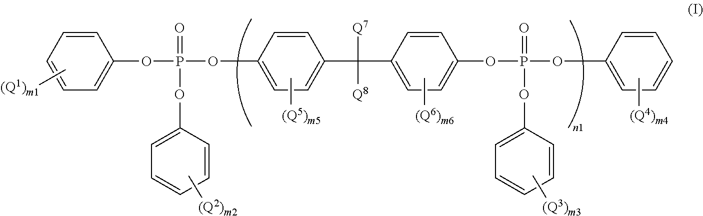
wherein in General Formula (I), each of Q¹, Q², Q³, and Q⁴ independently represents a hydrogen atom or an alkyl group having from 1 to 6 carbon atoms; each of Q⁵, Q⁶, Q⁷, and Q⁸ independently represents a hydrogen atom or a methyl group; each of m1, m2, m3, and m4 independently represents an integer of from 0 to 3; each of m5 and m6 independently represents an integer of from 0 to 2; and n1 represents an integer of from 0 to 10: 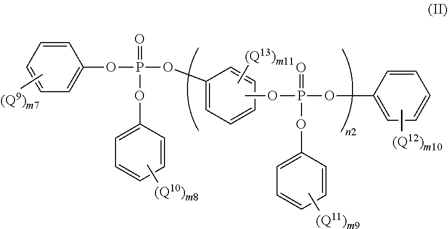
wherein in General Formula (II), each of Q⁹, Q¹⁰, Q¹¹, and Q¹² independently represents a hydrogen atom or an alkyl group having from 1 to 6 carbon atoms; Q¹³ represents a hydrogen atom or a methyl group; each of m7, m8, m9, and m10 independently represents an integer of from 0 to 3; m11 represents an integer of from 0 to 4; and n2 represents an integer of from 0 to 10.

7. The resin composition according to claim 1,
wherein the condensed phosphoric acid ester compound is an aromatic condensed phosphoric acid ester compound represented by the following Structural Formula (1):

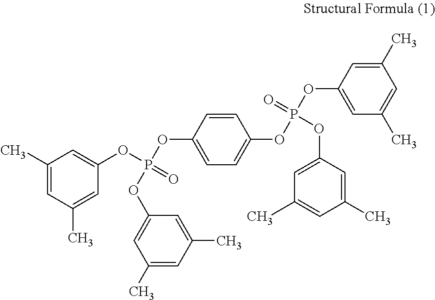

8. The resin composition according to claim 1, wherein the plasticizer is an adipate-based plasticizer and the condensed phosphoric acid ester compound is an aromatic condensed phosphoric acid ester compound represented by the following Structural Formula (1):

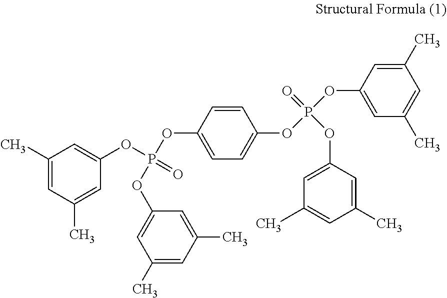

9. The resin composition according to claim 1, further comprising from 0.1 phr to 10 phr of a copolymer of methacrylate and a glycidyl compound.

10. A resin-molded product comprising:
a cellulose acetate propionate;
5 phr to 30 phr of at least one of plasticizer selected from an adipate-based plasticizer and a polyester-based plasticizer; and
5 phr to 50 phr of a condensed phosphoric acid ester compound.

11. The resin-molded product according to claim 10,
wherein a difference (absolute value) in solubility parameter (SP value), which is calculated from the following Fedor's equation based on heat of vaporization (Δei) and a molar volume (Δvi) of atoms or anatomic group in a chemical structure, between the plasticizer and the condensed phosphoric acid ester compound is 8 or less:
SP value=(ΣΔei/ΣΔvi)^{1/2}

12. The resin-molded product according to claim 10,
wherein the adipate-based plasticizer is one selected from bis(2-ethylhexyl)adipate, diisodecyl adipate, and benzyl octyl adipate.

13. The resin-molded product according to claim 10,
wherein the polyester-based plasticizer is one selected from poly(1,3-butanediol adipate), polyethylene adipate, polybutylene adipate, polyethylene succinate, and polybutylene succinate.

14. The resin-molded product according to claim 10,
wherein the condensed phosphoric acid ester compound is an aromatic condensed phosphoric acid ester compound.

15. The resin-molded product according to claim 10,
wherein the condensed phosphoric acid ester compound is a phosphoric acid ester compound represented by the following General Formula (I) or (II): 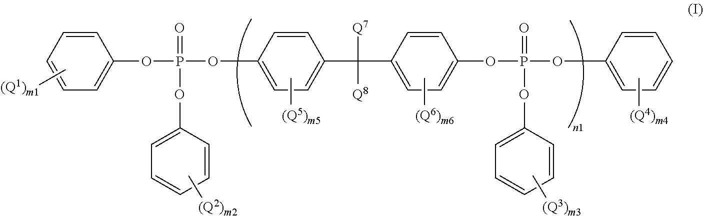
wherein in General Formula (I), each of Q¹, Q², Q³, and Q⁴ independently represents a hydrogen atom or an alkyl group having from 1 to 6 carbon atoms; each of Q⁵, Q⁶, Q⁷, and Q⁸ independently represents a hydrogen atom or a methyl group; each of m1, m2, m3, and m4 independently represents an integer of from 0 to 3; each of m5 and m6 independently represents an integer of from 0 to 2; and n1 represents an integer of from 0 to 10: 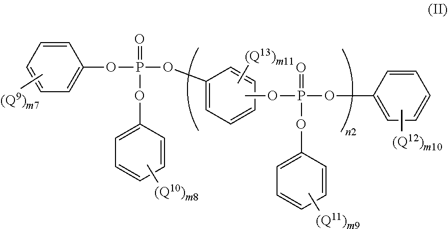
wherein in General Formula (II), each of Q⁹, Q¹⁰, Q¹¹, and Q¹² independently represents a hydrogen atom or an alkyl group having from 1 to 6 carbon atoms; Q¹³ represents a hydrogen atom or a methyl group; each of m7, m8, m9, and m10 independently represents an integer of from 0 to 3; m11 represents an integer of from 0 to 4; and n2 represents an integer of from 0 to 10.

16. The resin-molded product according to claim 10,
wherein the condensed phosphoric acid ester compound is an aromatic condensed phosphoric acid ester compound represented by the following Structural Formula (1):

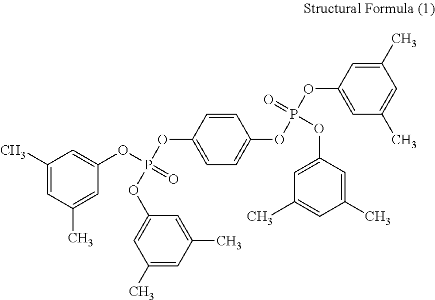

17. The resin-molded product according to claim 10, wherein the plasticizer is an adipate-based plasticizer and the condensed phosphoric acid ester compound is an aromatic condensed phosphoric acid ester compound represented by the following Structural Formula (1):

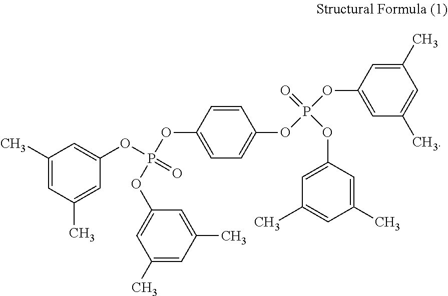 [SMILES: Cc1cc(C)cc(OP(=O)(Oc2ccc(OP(=O)(Oc3cc(C)cc(C)c3)Oc3cc(C)cc(C)c3)cc2)Oc2cc(C)cc(C)c2)c1]

18. The resin-molded product according to claim 10, further comprising 0.1 phr to 10 phr of a copolymer of methacrylate and a glycidyl compound.
